(19) United States
(12) Patent Application Publication
(10) Pub. No.: US 2006/0250582 A1
(43) Pub. Date: Nov. 9, 2006

(54) Apparatus for generating a multi color image over a projection surface

(76) Inventor: Eberhard Piehler, Lehesten (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/416,732

(22) Filed: May 3, 2006

(30) Foreign Application Priority Data
May 3, 2005 (DE) 10 2005 020 539.9

(51) Int. Cl. G03B 21/14

(52) U.S. Cl. 353/20

(57) ABSTRACT

The invention concerns a design for generating a multi color image over a projection surface to be applied in digital projectors with reflective LCD chips (LCoS) as image generating elements, in which the light stream, emitted from a white light source, passes over a color modulator, a polarization beam splitter or a color splitter and for the purpose of generating polarized light that divides the light from optical elements in two partial light streams of different polarization planes at the image generating elements and the light portions that serve for generating the images produced by the image generating elements will be reflected in the projection objective. According to the invention, two image generating elements are intended for at least one basic color.

### RELATED APPLICATION

The current application claims the benefit of priority to German Patent Application No. 10 2005 020 539.9 filed on May 3, 2005. Said application is incorporated by reference herein.

### FIELD OF THE INVENTION

The invention relates to apparatus for generating a multi color picture over a projection surface which can be used on digital projectors which use reflective LCD chips (LCOS) as image generating elements, by which the light stream emitted from a white light illumination source arrives at a color modulator and to an array of optical elements that serve the purpose of generating polarized light from the image generating elements and the light portions of the image generating which serve the image generation are reflected in the projection objective.

### BACKGROUND OF THE INVENTION

It is known that in projection devices with image generating elements based on liquid crystals, the nonpolarized light emitted from a lighting source is oriented regarding its polarization plane. For this purpose, the light portion that is not suitable for lighting is separated. This light portion is turned over to a polarization recovery system oriented to its polarization plane and is added to the light stream already used for the lighting.

If the polarization recovery system is not used, the quantity of light emitted from the light stream lighting source is reduced below 50%. The design of the recovery system takes place so that more light generates with the desired polarization, though it has the disadvantage that the etendue is enlarged. This has proven unfavorable in several applications, in which the size of the light spot from a lighting source can not be reduced at will and because of cost reasons it is not possible to use small image generating elements.

The spectral distribution of the light sources used frequently is not optimal. There is usually a deficit of a primary color, so the attainable brightness is limited by this color. For commonly used high pressure mercury lamps, this applies to the red color.

In the commonly known designs, such as the one described in WO 02/37175 A1, the drawback is that the spectral usage of the light stream emitted from the lighting source takes place independently from the spectral characteristics of the light source.

### SUMMARY OF THE INVENTION

Based on these drawbacks, the invention is a design for generating a multiple color images over a projection surface that, without requiring high additional design and technical expenses, allows the quantity of light available for projecting to be increased.

This task is solved by a design of the initially described kind, which according to the invention has at least two image generating elements intended for a basic color. This is advantageous for those basic colors with large spectral deficits, such as the red color, since the high pressure lamps commonly used in the projectors have a relatively small red output.

By using an additional image generating element for the basic color with the greatest spectral deficit, increased efficiency is obtained for this color, as well as the possibility of using additional light for this color portion.

In further analysis it is assumed that there is a light deficit for the red color. However, the described configuration variations can be modified easily in such a way that instead of red every other basic color can be equipped with two image generating elements.

On one hand, the structure can be implemented in such a way that it can work without the polarization recovery system and, for the red color, two polarization directions either a polarization recovery system or an additional source of light may be used.

For the configuration without a polarization recovery system, a color wheel provided with two segments advantageously can be used for color modulation between the lighting source and the polarization beam splitter to separate the light stream into two partial light streams, whereby a first segment reflects a first primary color (for example green) and a second segment reflects a second primary color (for example blue), while the respective other primary colors penetrate the color wheel.

The primary colors that pass through the color wheel are split up by the first polarization beam splitter into its two polarization directions (partial light streams). In both partial light streams, for example on a configuration with four image generating elements, the primary colors are directed respectively through a retarder and a polarization beam splitter to an image generating element. In each partial light stream, the “on light” turned in its polarization condition is merged again by the image generating elements by the polarization beam splitter and brought over a retarder into a common polarization.

A polarization beam splitter merges both partial image beam paths, so that the image created by the image generating elements, is displayed over an image surface by the projection objective.

It is also possible to modify the structure in such a way that no color wheel is present and a color splitter is used in each partial light stream from the lighting source before the retarder, so it is not necessary to uncouple the primary colors from the partial light streams. This reduces the spectral requirements of the retarder. The individual image generating elements are used only in each case for a primary color.

For particularly bright applications, is it convenient to use a configuration with a polarization recovery system and an additional color light source (red). In this configuration, the color wheel is not used and the polarization recovery system is used between the main light source and the polarization beam splitter. The division into partial light streams can take place now via a color splitter (separation of blue and/or green). Alternatively, a retarder may be used to alter the polarization direction rotation of a basic color (blue, green) and to carry out the division into the partial light streams using the polarization beam splitter. Over the color splitter and/or the polarization beam splitters, one of the partial light stream polarized red lights can be added. In further applications, the configuration is similar to the one above.

A further advantageous application intended for contrast improvement includes placing analyzers between the retarders arranged in the partial image beam paths and the optical element for adjusting the polarization planes of the partial image beam paths and/or before the retarders in the partial light streams of the light source.

It is also possible, to replace the polarization beam splitter cubes by other polarization optical elements with the corresponding effect, such as polarization divisor plates.

### BRIEF DESCRIPTION OF THE DRAWINGS

The invention based design is described in further detail below. The respective figures show:

FIG. 1 is a schematic view of a projector with four image generating elements and segmented color wheel in accordance with the invention,

FIG. 2 is a schematic view of a projector with four image generating elements without a segmented color wheel,

FIG. 3 is a schematic view of a projector with four image generating elements, without segmented color wheel and with an additional lighting source, with which the separation into partial light streams takes place with a polarization beam splitter, and

FIG. 4 is a schematic view of a projector with four image generating elements, without segmented color wheel and an additional lighting source, with which the division into partial light streams takes place through a color splitter.

### DETAILED DESCRIPTION OF THE INVENTION

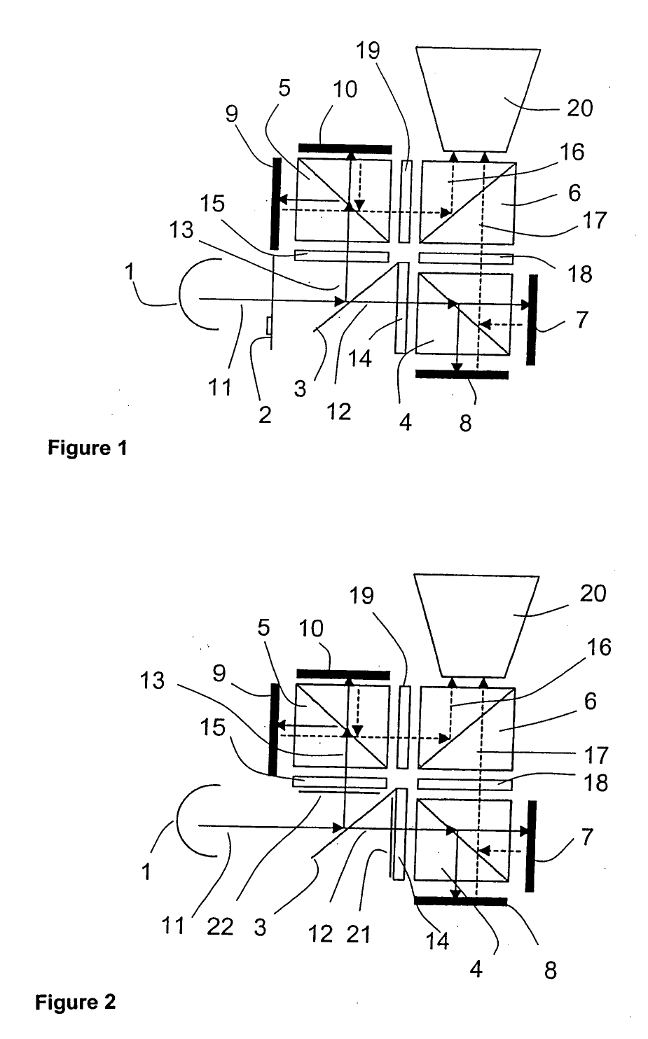

FIG. 1 shows the invention in schematic form, with a now polarized lighting source 1, a color wheel 2 provided with two segments, the polarization beam splitter plate 3 as well as three polarization beam splitter cubes 4, 5 and 6. The light emitting surfaces of polarization beam splitter cubes 4 and 5 direct light to the image generating elements 7, 8, 9 and 10 are LCoS chips.

The light emitted from lighting source 1 gets first to color wheel 2. Color wheel 2 is built in such a way that one segment reflects green light and the other segment reflects blue light, while the other primary colors are correspondingly transmitted. At polarization beam splitter plate 3, which can be built for example as “Moxtek beam splitters”, light stream 11 is split up into two partial light streams 12 and 13 with different polarization planes, lying at 90 degrees between each other.

The red light portion arrives in the partial light stream 12 in the transmission over polarization beam splitter cube 4 at the image generating element 7 and in the partial light stream 13, reflecting over polarization beam splitter cube 5 at the image generating element 9. Retarders 14 and 15 rotate the polarization direction of the green and blue colors, so that on the image generating elements 8 and 10 alternate the green and blue light portions on polarization beam splitter cube 4 and polarization beam splitter cube 5.

It is possible to shift the color allocation on image generating elements 7 and 8 as well as on 9 and 10 within the partial light flows 12 and 13, by modifying the retarders 14 and 15 accordingly.

The light rays emitted from image generating elements 7, 8, 9 and 10 needed for the projection, will be brought to a polarization condition within the partial image beam paths 16 and 17 by means of retarders 18 and 19, and then will be reunited by polarization beam splitter cube 6 and will arrive in such a way to projection objective 20. The arrangement displayed in the example can also be used for 3D representations using polarizing eyeglasses. The image for one eye will be generated by partial light flow 12 and by partial image beam path 17, and the image for the other eye by partial light flow 13 and by partial image beam path 16.

FIG. 2 shows a schematic of the invention based design, in which there is no segmented color wheel 2, as represented in FIG. 1. In place of the segmented color wheel 2, are partial light flows 12 and 13, and color splitters 21 and 22 before the corresponding retarders 14 and 15, whereby color divisor 21 reflects basic color blue and color divisor 22 reflects basic color green, so that the undesired primary colors in partial light flows 12 and 13 are uncoupled. This embodiment, in which the color modulation takes place only in partial light flows 12 and 13, reduces the spectral requirements of retarders 14 and 15. The further beam trajectory is similar to the one on FIG. 1.

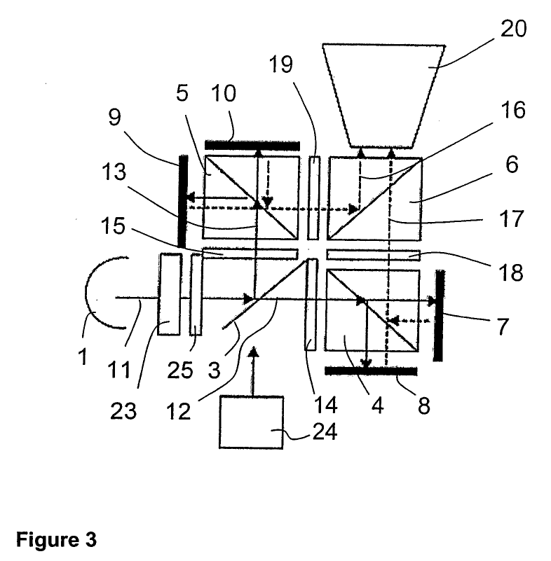

FIG. 3 shows a schematic of the invention based design, lacking color wheel 2 used in FIG. 1. Additionally, in order to increase the further usable light flow 11, a polarization recovery system 23 and a retarder 25 are placed between lighting source 1 and polarization beam splitter plate 3, which turn the polarization of one of the basic colors green or blue. Light flow 11 from lighting source 1 is now divided into partial light flows 12 and 13 by polarization beam splitter plate 3.

Furthermore, FIG. 3 depicts a further lighting source 24, which supplies the required red light for the polarization of the polarization beam splitter plate 3, so that in both partial light flows 12 and 13, basic color red is included. This has the advantage that the color deficit of lighting source 1 can be compensated, for example, when high pressure lamps with small red light outputs are being used. The further treatment of partial light flows 12 and 13 is similar to the one on FIG. 2.

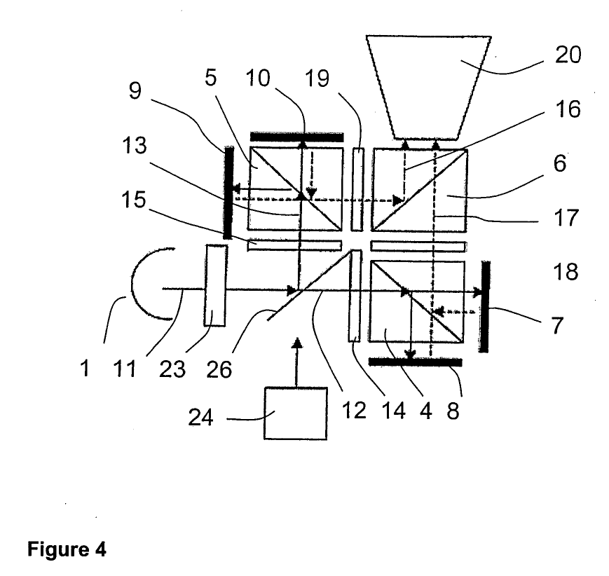

FIG. 4 shows a schematic of the invention based design, lacking the color wheel 2 used in FIG. 1 similarly to FIG. 3, a polarization recovery system 23 is used, which brings light flow 11 the lighting source 1 into a polarized condition. However, the division into partial light flows 12 and 13, contrary to the configuration shown on FIG. 3, does not take place with polarization beam splitter plate 3, but with color splitter 26, which is why retarder 25 also used in FIG. 3 can be omitted. Similar to FIG. 3, the polarized red light from lighting source 24 is supplied to color divisor 26, so that both partial light flows 12 and 13 include the red color.

| | |
|---|---|
| 1 | Reference symbol list |
| 2 | Lighting source (white light) |
| 3 | Color wheel |
| 4, 5, 6 | Polarization beam splitter plate |
| 7, 8, 9, 10 | Polarization beam splitter cube |
| 11 | Image generating elements (LCoS chips) |
| 12, 13 | Light flow |
| 14, 15 | Partial light flows |
| 16, 17, 18, 19 | Retarders |
| 20 | Partial image beam path |
| 21, 22 | Projection objective |
| 23 | Color splitter |
| 24 | Polarization recovery system |
| 5, 6 | Lighting source (red light) |

1. An apparatus to generate a multi color image to be projected onto a projection surface to be used in digital projectors having reflective LCD chips (LCOS) as image generating elements, in which a substantially white light beam passes from a light source, through a color modulator, a polarization beam splitter or a color splitter to produce polarized light in two partial light beams having different polarization planes at the image generating elements and the light reflective portions of the image generating elements reflect the two partial light beams from the image generating elements into the projection objective, wherein two image generating elements are intended for at least one basic color.

2. The apparatus according to claim 1, further comprising polarization beam splitter cubes to adjust the polarization planes of the partial light beams.

3. The apparatus according to claim 1, further comprising a color wheel having at least two color segments to modulate color between the light source and the polarization beam splitter for the separation of the substantially white light stream into two partial light beams whereby one segment reflects a first primary color and another segment reflects a second primary color, wherein different primary colors penetrate color wheel at each color segment.

4. The apparatus according to claim 1, further comprising retarders arranged in the partial light beams and in image beam paths.

5. The apparatus according to claim 1, wherein color splitters placed before retarders in the partial light beams act to uncouple any undesired color portions.

6. The apparatus according to claim 1, further comprising a polarization recovery system placed between the light source and the polarization beam splitter comprising a subsequent retarder and a second light source, which supplies guided light of a primary color from the polarization beam splitter to a light stream.

7. The apparatus according to claim 1, further comprising, analyzers placed between retarders and/or before the retarders and an optical element to adjust the polarization planes of the partial image beam paths whereby image contrast is improved.

8. A digital color image projector, comprising:
reflective image generating elements comprising reflective LCD chips;
a broad spectrum light source;
a color modulator through which light emitted from the broad spectrum light source passes;
a polarizing beam splitter or a color splitter following the color modulator to produce two partial beams of polarized light having different planes of polarization;
the reflective image generating elements following the polarizing beam splitter or the color splitter;
a projection objective following the reflective image generating elements; and
wherein two of the reflective image generating elements receive at least one basic color.

9. The apparatus according to claim 1, further comprising polarization beam splitter cubes to adjust the polarization planes of the partial beams of polarized light.

10. The apparatus according to claim 9, wherein the color modulator comprises a color wheel comprising two color segments wherein a first segment reflects a first primary color and a second segment reflects a second primary color and the color wheel is located between the light source and the polarization beam splitter cubes to separate the light emitted from the broad spectrum light source into two partial beams.

11. The apparatus according to claim 9, further comprising retarders arranged in the partial beams of polarized light.

12. The apparatus according to claim 11, further comprising color splitters placed before the retarders in the partial beams of polarized light to uncouple undesired color ranges.

13. The apparatus according to claim 11, further comprising a polarization recovery system having an additional retarder and a second lighting source, to supply light of a primary color which is deficient in the broad spectrum light source.

14. The apparatus according to claim 9, further comprising analyzers located following the retarders to adjust polarization planes.

15. A method of projecting a digital color image, comprising:
directing a light beam from a broad spectrum light source;
modulating the light beam by passing it through a color modulator;
passing the light beam through a polarizing beam splitter or a color splitter following the color modulator to produce two partial beams of polarized light having different planes of polarization;
reflecting the partial light beams at least partially off of reflective image generating elements following the polarizing beam splitter or the color splitter into a projection objective following the reflective image generating elements; and
directing at least one basic color to two of the reflective image generating elements.

16. The method according to claim 15, further comprising adjusting the polarization planes of the partial beams of polarized light polarization via beam splitter cubes.

17. The method according to claim 15, further comprising reflecting a first primary color from a first color wheel segment and reflecting a second primary color from a second color wheel segment.

18. The method according to claim 16, further comprising placing retarders in the partial beams of polarized light.

19. The method according to claim 12, further comprising placing color splitters before the retarders in the partial beams of polarized light to uncouple undesired color ranges.

20. The method according to claim 15, further comprising supplying light of a primary color from a second light source through an additional retarder and adjusting the polarization planes via analyzers.
